(19) United States
(12) Patent Application Publication
(10) Pub. No.: US 2005/0242663 A1
(43) Pub. Date: Nov. 3, 2005

(54) Traction regulator having pilot control unit

(76) Inventor: Andreas Erban, Loechgau (DE)

Correspondence Address: KENYON & KENYON, ONE BROADWAY, NEW YORK, NY, 10004, US

(21) Appl. No.: 11/054,126

(22) Filed: Feb. 8, 2005

(30) Foreign Application Priority Data
Apr. 30, 2004 (DE) 102004021374.7

(51) Int. Cl. B60T 8/34

(52) U.S. Cl. 303/139

(57) ABSTRACT

A device for traction regulation of the driven wheels of a motor vehicle, including an integration regulator, which produces a control variable for an actuator as a function of a regulation deviation. The traction of the vehicle may be improved significantly, when driving off-road in particular, if the traction regulator includes a pilot control unit, which produces a pilot control value, supplied to the integration regulator as the starting value of the regulation, as a function of roadway surface foundation information.

### FIELD OF THE INVENTION

The present invention relates to a device for traction regulation of the driven wheels of a motor vehicle, as well as a corresponding method.

### BACKGROUND INFORMATION

Traction regulation systems are used for the purpose of improving the traction of a vehicle, on slick or rough road surface foundations in particular. Systems of this type typically include a control unit having a traction regulating algorithm, a sensor system for recording various driving condition variables, such as the wheel speeds, and an electromechanical braking system for performing a control intervention. The regulated variable is typically a wheel velocity or a wheel slip.

During travel on a slick roadway or off-road, it frequently occurs that individual wheels of the vehicle spin too strongly. If too high a drive slip occurs at a driven wheel, the traction regulation system intervenes via appropriate activation of the associated wheel brake during operation to obtain traction. The drive torque of the vehicle engine is thus diverted to another wheel having higher drive potential. The traction of the vehicle may thus be improved.

The regulating algorithm is typically designed as a compromise between maximum possible traction (rapid compensation of the wheel slip) and maximum comfort (slow compensation of the wheel slip). Maximum traction is achieved by the most rapid possible compensation of the regulatory deviation. However, this comes at the cost of driving comfort, since a rapid and strong control intervention results in jerky driving behavior. The gradient of the braking torque buildup is therefore typically limited for reasons of comfort, but then at the cost of traction.

A comfortable setting of the traction regulator is especially disadvantageous when driving off-road, since the vehicle requires maximum traction in steep or rough country, for example, so that it does not come to a standstill.

### SUMMARY OF THE INVENTION

It is therefore an object of the present invention to optimize a traction regulation system in regard to driving comfort and traction as a function of the road surface foundation.

This object is achieved according to the present invention.

An important aspect of the present invention is to adapt the regulating behavior of an integration regulator of the traction regulation system to the road surface foundation. For this purpose, the system includes a pilot control unit that generates a pilot control value as a function of information about the road surface foundation, which is supplied to the integration regulator as the starting value of the regulation. This has the important advantage that the integration regulator does not have to integrate up from a starting value (zero), as is typical, but rather may begin at a higher starting value so that the operating point (at which the regulation deviation becomes zero) is reached significantly more rapidly.

The term “integration regulator” is not to be understood in this case solely as a regulating algorithm which performs a mathematical integration, but rather also as regulating algorithms of the type which produce a regulator output variable that increases continuously or step by step, such as a regulator having a counter, step, or ramp function.

In addition to the adaptation of the starting value of the regulation, another regulator variable, such as the regulation amplification, a regulator parameter, or a setpoint variable, may be adapted to the road surface foundation. This applies both to the integration regulator and to another regulator component of the traction regulator, such as a P regulator. Thus, for example, the regulator amplification of the P regulator may also be set as a function of the road surface foundation information. When driving off-road, it is possible in this way, for example, to capture a strongly slipping (e.g., raised off the ground) wheel very rapidly again and divert the drive torque to another driven wheel to improve traction.

Any information which is an indication of the current road surface foundation is to be understood as “road surface foundation information” in this case. The current road surface foundation may be measured using a sensor system or estimated from different driving status variables, for example. For example, the driving resistance of the vehicle, which is calculated from the ratio between the drive torque of the vehicle engine and the acceleration actually implemented, provides an indication of the road surface information. This value is preferably supplied to the pilot control unit, which then calculates an associated pilot control value (starting value) and thus adapts the regulation behavior of the traction regulator to the road surface foundation.

According to a first embodiment of the present invention, the pilot control value is a function of the drive torque at the drivetrain and/or a variable proportional thereto. In this way, in the event of high drive torques, which indicate especially difficult terrain, the pilot control value may be increased accordingly. A significantly slipping (raised off the ground) wheel will thus be captured again rapidly.

According to another embodiment of the present invention, the pilot control value is preferably a function of the vehicle velocity or a variable proportional thereto, such as a wheel velocity. The adaptation of the regulation behavior may thus be restricted to specific velocity ranges and, for example, only performed in a lower velocity range, between 0 m/sec and 3 m/sec, for example.

According to a further embodiment of the present invention, the pilot control value is also a function of the engine speed or a variable proportional thereto. When at low engine speeds, it is to be considered that an automatic brake intervention is not to be performed too strongly, since the vehicle engine may otherwise stall. The pilot control value at low engine speeds is therefore preferably smaller than at high engine speeds.

A further improvement of the traction when driving off-road or on foundations slick on one side (μ-split) may be achieved if the behavior of a wheel, in particular the curve of the wheel speed, is analyzed during a traction regulation and the pilot control value for the regulation intervention at another wheel is determined as a function thereof. The traction regulator learns the adhesive properties of the foundation from the slipping behavior of one wheel and may therefore at least qualitatively foresee the future slipping behavior of another wheel. Depending on how strong the drive slip of the first wheel is, another wheel, to which the drive torque (lock-up torque) is transmitted by the braking intervention, may be regulated more strongly or more weakly, i.e., a higher or lower pilot control value may be set. This is to be illustrated on the basis of the following example:

When driving on a foundation which is slick on one side (μ-split) using an all-wheel-drive vehicle, one rear wheel first goes into high drive slip, for example. As soon as the rear wheel is braked actively, the drive torque increases at the corresponding front wheel, which subsequently also enters drive slip. The pilot control value for the integration regulator of the front wheel may now be set on the basis of the slip behavior of the rear wheel and, for example, a higher pilot control value may be set if the rear wheel has shown very strong drive slip.

### BRIEF DESCRIPTION OF THE DRAWINGS

FIG. 1 shows a schematic block diagram of a traction regulator having a pilot control unit.

FIG. 2a shows the curve of a regulation deviation with and without pilot control.

FIG. 2b shows the curve of a manipulated variable with and without pilot control.

### DETAILED DESCRIPTION

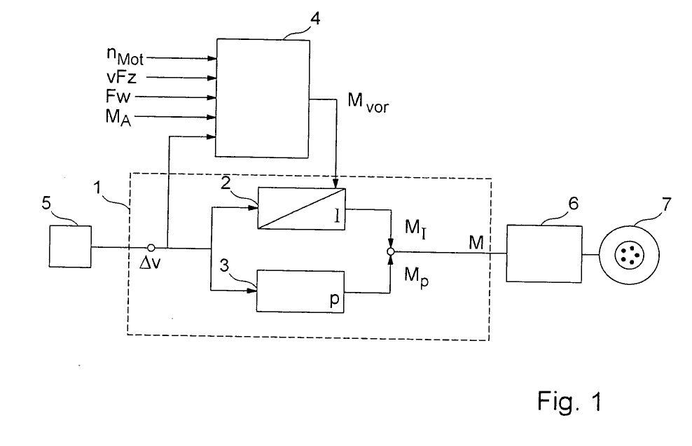

FIG. 1 shows a schematic view of a traction regulation system having a traction regulator 1, which is stored as software in a control unit, for example, a sensor system 5 for detecting different driving status variables, and an active braking system 6 as the actuator of the regulation. In this exemplary embodiment, regulator 1 is implemented as a PI regulator and includes an I regulator 2 (integration regulator) and a P regulator 3 (proportional regulator). Regulating algorithm 2, 3 is typically provided for each driven wheel 7.

If a wheel 7 enters drive slip and regulation deviation Δv exceeds a predefined threshold value, regulator 1 produces a manipulated variable M, such as a braking torque, which is converted into a corresponding brake pressure that is exerted by braking system 6 in order to capture slipping wheel 7 again.

When driving off-road in particular, it is important for the drive torque to be diverted as rapidly as possible to other wheels having more traction potential, i.e., for the highest possible lock-up torque to be built up as rapidly as possible. The integration amplification of integration regulator 2 and the amplification of proportional regulator 3 may not be increased arbitrarily strongly for reasons of stability of the closed control loop. Therefore, some time always passes before a sufficient braking torque is built up at the slipping wheel. However, during this time a traction setback occurs and in the worst case the vehicle comes to a standstill, which is disadvantageous when driving off-road in particular.

In order to avoid this, the traction regulation system includes a pilot control unit 4 that produces a “pilot control value” Mᵥₒᵣ, which is supplied to integration regulator 2 as the starting value. Integration regulator 2 thus no longer integrates from a starting value equal to “zero,” but rather, depending on the roadway surface foundation, from a higher value so that the operating point may be reached significantly more rapidly and therefore the required braking torque may be built up significantly more rapidly.

Set pilot control value Mᵥₒᵣ is a function of the roadway surface foundation, which is included in the calculation of the pilot control value via driving resistance Fw. Driving resistance Fw results from the ratio between the exerted drive torque (or a proportional variable) and the thus implemented acceleration of the vehicle, and is therefore a measure of the roadway surface foundation. For example, when driving in sand, the vehicle acceleration is significanty lower than when driving on asphalt.

In addition to driving resistance Fw, pilot control unit 4 also receives drive torque M_{A} as an input variable. Pilot control value Mᵥₒᵣ may thus also be adapted to different drive torques M_{A} and, for example, in the event of a high drive torque M_{A}, a higher pilot control value Mᵥₒᵣ may be generated than in the event of a lower drive torque M_{A}.

Pilot control value Mᵥₒᵣ is additionally a function of vehicle velocity vFz. The adaptation of integration regulator 2 may thus be restricted to predefined velocity ranges, such as the starting phase of the vehicle.

Engine speed nₘₒₜ forms a further optional input variable of pilot control unit 4. Pilot control value Mᵥₒᵣ may thus be calculated as a function of engine speed nₘₒₜ. In vehicles without an automatic transmission, a minimum engine speed may thus be provided, for example, which the engine must exceed for a pilot control value Mᵥₒᵣ to be output at all. At very low speeds, there is preferably no adaptation by I regulator 2, so that the internal combustion engine does not stall unintentionally.

The input variables of pilot control unit 4 are all optional except for driving resistance Fw.

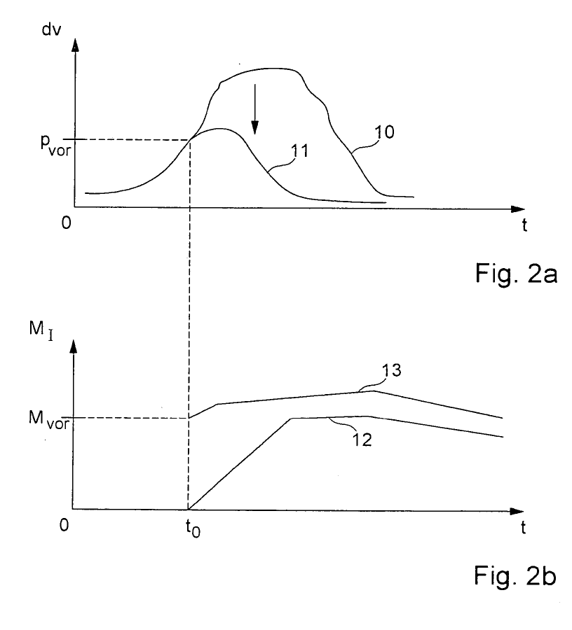

FIG. 2a shows the curve of control variable dv (differential wheel velocity) during a regulation with and without pilot control. In this case, reference numeral 10 identifies the curve without pilot control, and reference numeral 11 identifies the curve with pilot control. Both curves 10, 11 show that observed wheel 7 first builds up slip until a regulatory threshold is exceeded at time t0, which triggers a regulation intervention by braking system 6. The slip subsequently reaches a maximum value and is then reduced again. As shown, the maximum slip without pilot control (10) is significantly higher than with pilot control (11). Wheel 7 is additionally captured again significantly more rapidly than without pilot control (curve 10).

FIG. 2b shows regulator output variable M_{I} of I regulator 2. In this case, reference numeral 12 identifies the curve of regulator output variable Δv without pilot control and reference numeral 13 identifies the curve of the regulator output variable with pilot control. In the event of regulation without pilot control (curve 12), I regulator 2 integrates starting from the starting value “zero.” Output variable M_{I} increases in this case in a ramp shape with a predefined gradient until the operating point is reached.

In contrast, in the event of regulation with pilot control, a pilot control value Mᵥₒᵣ is produced at the beginning of the regulation, which is supplied to I regulator 2 as the starting value. I regulator 2 therefore requires significantly less time until reaching the operating point. Slipping wheel 7 is thus captured again significantly more rapidly.

In addition to the adaptation of the starting value of I regulator 2, other regulator parameters may also be varied as a function of the roadway surface foundation. Thus, for example, a regulator amplification, i.e., the gradient of the braking torque buildup, a parameter of the regulating algorithm, or any other arbitrary regulator variable may be varied as a function of the roadway surface foundation. This applies both to the I regulator and the P regulator. The traction regulation may thus be adapted as desired to the roadway surface foundation.

1. A device for traction regulation of driven wheels of a motor vehicle, comprising:
an actuator;
a regulator for producing a control variable for the actuator as a function of a regulation deviation; and
a pilot control unit for producing a pilot control value, supplied to the regulator as a starting value of the regulation, as a function of roadway surface foundation information.

2. The device according to claim 1, wherein the regulator is an integration regulator.

3. The device according to claim 1, wherein the pilot control value is a function of one of a vehicle velocity and a proportional variable.

4. The device according to claim 1, wherein the pilot control value is a function of one of an engine speed and a proportional variable.

5. The device according to claim 1, wherein the regulator is a PI regulator.

6. The device according to claim 1, further comprising a device for determining information about a wheel speed of a wheel during a traction regulation and relaying the information to the pilot control unit, which produces a pilot control value for another wheel as a function of the information.

7. A method for traction regulation of driven wheels of a motor vehicle, the method comprising:
producing a control variable for an actuator using a regulator as a function of a regulation deviation of a wheel-specific characteristic variable; and
producing roadway surface foundation information and transmitting the information to a pilot control unit, which determines a pilot control value, supplied to the regulator as a starting value of the regulation, as a function of the information supplied.

8. The method according to claim 7, wherein the pilot control value is a function of one of a vehicle velocity and a proportional variable.

9. The method according to claim 7, wherein the pilot control value is a function of one of an engine speed and a proportional variable.
